(19) United States
(12) Patent Application Publication
(10) Pub. No.: US 2010/0188443 A1
(43) Pub. Date: Jul. 29, 2010

(54) SENSOR-BASED FEEDBACK FOR DISPLAY APPARATUS

(75) Inventors: Stephen R. Lewis, Reading, MA (US); Jignesh Gandhi, Burlington, MA (US); John J. Fijol, Shrewsbury, MA (US); Abraham McAllister, Annandale, VA (US)

Correspondence Address: ROPES & GRAY LLP, PATENT DOCKETING 39/41, ONE INTERNATIONAL PLACE, BOSTON, MA, 02110-2624, US

(73) Assignee: Pixtronix, Inc, Andover, MA (US)

(21) Appl. No.: 12/523,863

(22) PCT Filed: Jan. 18, 2008
(86) PCT No.: PCT/US08/00714

§ 371 Date: Mar. 17, 2010

Related U.S. Application Data
(60) Provisional application No. 60/881,797, filed on Jan. 19, 2007.

(51) Int. Cl. G09G 5/10

(52) U.S. Cl. 345/691; 345/690

(57) ABSTRACT

The invention relates to methods and apparatus for feedback control of image and color quality in a direct-view MEMS display apparatus. The display apparatus includes a lamp capable of providing light, a sensor capable of detecting information indicative of characteristics of light provided by the lamp and outputting a sensor signal based at least partially on the information, and control circuitry for controlling illumination of the lamp based at least partially on the sensor signal.

### REFERENCE TO RELATED APPLICATIONS

This application claims the benefit of U.S. Provisional Patent Application Ser. No. 60/881,797, filed on Jan. 19, 2007, entitled “Feedback Control of Display Apparatus Color Point”, which is incorporated by reference herein in its entirety.

### FIELD OF THE INVENTION

In general, the invention relates to the field of imaging displays, in particular, the invention relates to circuits for controlling backlights incorporated into imaging displays.

### BACKGROUND OF THE INVENTION

Conventional liquid crystal displays depend on red, green, and blue color filters to produce a spectrum of available colors in an image (known as the color gamut). Field sequential color displays improve upon color-filter displays in the areas of resolution, power efficiency, and color gamut. A field sequential color (FSC) display provides color by rapidly alternating the color of the backlight, and projecting a sequence of separate red, green and blue images. The eye averages the several images over time to form the impression of a single image with appropriate color. Instead of a pixel requiring 3 spatial light modulators, one in front of each color filter, an FSC display requires only a single light modulator per pixel. Field sequential displays do not suffer a loss of power efficiency due to absorption in a color filter. And FSC displays make maximum use of the color purities available from modern light emitting diodes (LEDs), thereby providing a range of colors exceeding those available from color filters, i.e. a wider color gamut.

Field sequential color displays employ control circuitry for modulating the intensities of the colored lamps. The control circuitry ensures that luminous intensities from the colored lamps are balanced for appropriate color mixing, in order for example, to achieve a reproducible white point or white color in the display.

In order to reproduce correct colors in a field sequential display, precise information is required about the radiant colors, often specified by their u′, v′ points in a YUV color space, for each of the lamps employed. Correct color reproduction can be complicated, however, since different color LEDs have different responses towards temperature and degrade differently with time. The variations of color point with temperature and lifetime may not be entirely predictable, especially the response against lifetime degradation. As an example, a well-balanced white color point at room temperature can drift towards the color red at low temperatures and towards greenish-blue at high temperatures. Similar changes occur at other color points besides white. A need exists for field sequential color control circuits that compensate for changes in LED intensity to preserve color quality. A need also exists for field sequential color control circuits that can adjust lamp intensities in response to ambient illumination.

### SUMMARY OF THE INVENTION

According to one aspect the invention relates to a field sequential color display that includes a plurality of lamps and a sensor for detecting information indicative of characteristics of light provided by each of the lamps. The sensor outputs a sensor signal based at least in part on the detected information. In one embodiment, the sensor includes a photosensor capable of measuring light intensity. In one embodiment, the photosensor measures the intensity of ambient light and/or the intensity of the light emitted by one or more of the lamps. In another embodiment, the field sequential color display includes at least one sensor for detecting the intensity of the light emitted by the lamps and at least a second sensor for detecting ambient light intensity. In one particular embodiment, the field sequential color display includes one sensor per lamp or per lamp color. In another embodiment, the sensor includes a thermal sensor.

In one embodiment, the field sequential color display includes a plurality of light modulators for modulating the light emitted by the plurality of lamps. Suitable light modulators include a broad range of MEMS light modulators, including shutter-based MEMS modulators, electrowetting-based MEMS modulators, frustrated internal reflection or light-tap-based MEMS modulators, interferometric-based MEMS modulators, and rotating mirror-based MEMS modulators. Amongst shutter-based MEMS modulators, the invention is applicable to shutters that move either in a plane parallel to the display substrate or transverse to the substrate. In one embodiment, the sensor is formed on the same substrate as the MEMS modulators. Additional suitable light modulators include liquid crystal modulators, such as ferroelectric liquid crystal modulators or optically compensated bend mode liquid crystal modulators.

The field sequential color display also includes a control circuitry for controlling the illumination of each of the lamps. The control circuitry includes both timing circuitry and lamp driver circuitry. In one embodiment, the control circuitry includes a memory for storing data related to various operating temperature ranges for use in conjunction with a sensor capable of measuring temperature. In another embodiment, the control circuitry adjusts a number of digital bit levels used to display an image based on the sensor signal.

The timing circuitry determines lengths of time each of the plurality of lamps should be illuminated and outputs a timing signal indicative thereof. In various embodiments, the timing circuitry determines the lengths of time according to a time-division gray scale or analog grayscale process. The timing circuitry may also determine the lengths of time based on the sensor signal. In one embodiment, the timing circuitry also controls the actuation of the light modulators included in the display.

The lamp driver circuitry outputs power for to illuminate the plurality lamps based on the sensor signal and the timing signals output by the timing circuitry. In one embodiment, the lamp driver circuitry adjusts the amplitude of power output to the lamps based on the sensor signal. The lamp driver circuitry adjusts the amplitude by adjusting either the current or voltage supplied to at least one of the lamps.

According to another aspect, the invention relates to a direct-view MEMS display that includes a lamp for providing light and a sensor capable of detecting information indicative of characteristics of light provided by the lamp and outputting a sensor signal indicative thereof. The direct-view MEMS display also includes control circuitry, such as the control circuitry referred to above, that controls the illumination of the lamp based at least in part on the sensor signal.

### BRIEF DESCRIPTION OF THE DRAWINGS

The foregoing discussion will be understood more readily from the following detailed description of the invention with reference to the following drawings:

FIG. 1A is an isometric view of display apparatus, according to an illustrative embodiment of the invention;

FIG. 1B is a block diagram of control circuitry for the display apparatus of FIG. 1A, according to an illustrative embodiment of the invention;

FIG. 2A is a perspective view of an illustrative shutter-based light modulator suitable for incorporation into the MEMS-based display of FIG. 1A, according to an illustrative embodiment of the invention;

FIG. 2B is a cross-sectional view of a rollershade-based light modulator suitable for incorporation into the MEMS-based display of FIG. 1A, according to an illustrative embodiment of the invention;

FIG. 2C is a cross sectional view of a light-tap-based light modulator suitable for incorporation into an alternative embodiment of the MEMS-based display of FIG. 1A, according to an illustrative embodiment of the invention;

FIG. 2D is a cross sectional view of an electrowetting-based light modulator suitable for incorporation into an alternative embodiment of the MEMS-based display of FIG. 1A, according to an illustrative embodiment of the invention;

FIG. 3A is a schematic diagram of a control matrix suitable for controlling the light modulators incorporated into the MEMS-based display of FIG. 1A, according to an illustrative embodiment of the invention;

FIG. 3B is a perspective view of an array of shutter-based light modulators connected to the control matrix of FIG. 3A, according to an illustrative embodiment of the invention;

FIGS. 4A and 4B are plan views of a dual-actuated shutter assembly in the open and closed states respectively, according to an illustrative embodiment of the invention.

FIGS. 5A, 5B, and 5C are cross-sectional views of a display apparatus, according to an illustrative embodiment of the invention;

FIG. 6 is a timing diagram illustrating the coordination of various image formation events, according to an illustrative embodiment of the invention;

FIG. 7 illustrates three alternate pulse profiles for lamp illumination as may be implemented by control circuitry, according to illustrative embodiments of the invention.

FIG. 8 depicts a block diagram representing exemplary closed-loop feedback control circuitry based on a photodetector, according to illustrative embodiments of the invention;

FIG. 9 depicts a block diagram representing exemplary open-loop feedback control circuitry based on a thermal sensor, according to illustrative embodiments of the invention; and

### DESCRIPTION OF CERTAIN ILLUSTRATIVE EMBODIMENTS

To provide an overall understanding of the invention, certain illustrative embodiments will now be described, including apparatus and methods for displaying images. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

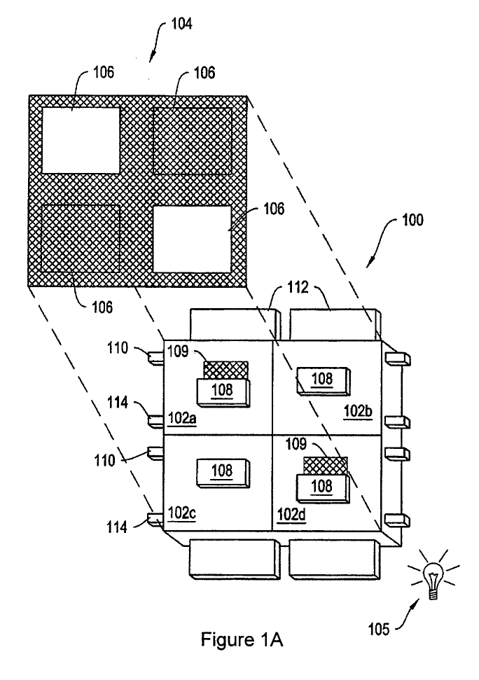

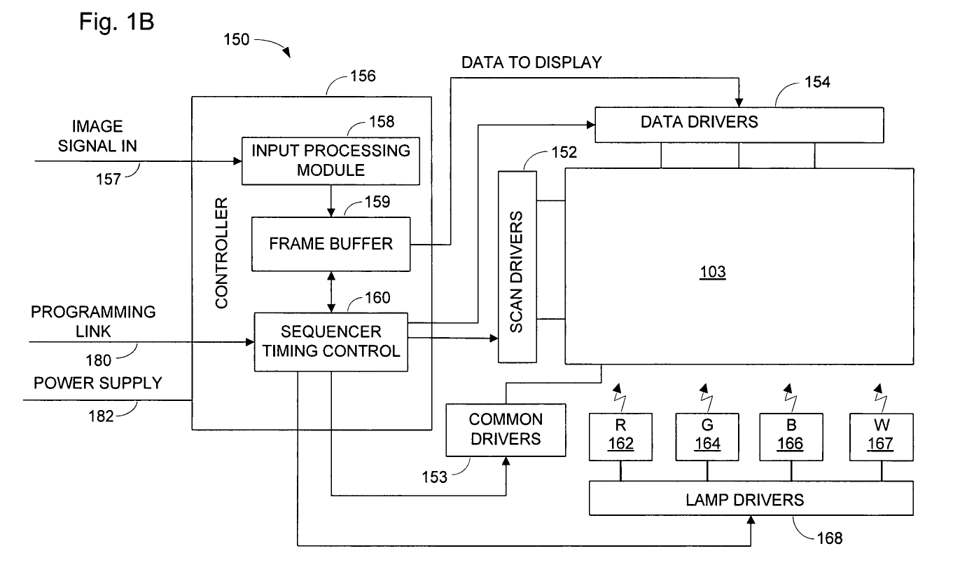

FIG. 1A is a schematic diagram of a direct-view MEMS-based display apparatus 100, according to an illustrative embodiment of the invention. The display apparatus 100 includes a plurality of light modulators 102a-102d (generally “light modulators 102”) arranged in rows and columns. In the display apparatus 100, light modulators 102a and 102d are in the open state, allowing light to pass. Light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e. by use of a frontlight. In one of the closed or open states, the light modulators 102 interfere with light in an optical path by, for example, and without limitation, blocking, reflecting, absorbing, filtering, polarizing, diffracting, or otherwise altering a property or path of the light.

In the display apparatus 100, each light modulator 102 corresponds to a pixel 106 in the image 104. In other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide grayscale in an image 104. With respect to an image, a “pixel” corresponds to the smallest picture element defined by the resolution of the image. With respect to structural components of the display apparatus 100, the term “pixel” refers to the combined mechanical and electrical components utilized to modulate the light that forms a single pixel of the image.

Display apparatus 100 is a direct-view display in that it does not require imaging optics. The user sees an image by looking directly at the display apparatus 100. In alternate embodiments the display apparatus 100 is incorporated into a projection display. In such embodiments, the display forms an image by projecting light onto a screen or onto a wall. In projection applications the display apparatus 100 is substantially smaller than the projected image 104.

Direct-view displays may operate in either a transmissive or reflective mode. In a transmissive display, the light modulators filter or selectively block light which originates from a lamp or lamps positioned behind the display. The light from the lamps is optionally injected into a light guide or “backlight”. Transmissive direct-view display embodiments are often built onto transparent or glass substrates to facilitate a sandwich assembly arrangement where one substrate, containing the light modulators, is positioned directly on top of the backlight. In some transmissive display embodiments, a color-specific light modulator is created by associating a color filter material with each modulator 102. In other transmissive display embodiments colors can be generated, as described below, using a field sequential color method by alternating illumination of lamps with different primary colors.

Each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material.

The display apparatus also includes a control matrix connected to the substrate and to the light modulators for controlling the movement of the shutters. The control matrix includes a series of electrical interconnects (e.g., interconnects 110, 112, and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{we}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B is a block diagram 150 of the display apparatus 100. Referring to FIGS. 1A and 1B, in addition to the elements of the display apparatus 100 described above, as depicted in the block diagram 150, the display apparatus 100 includes a plurality of scan drivers 152 (also referred to as “write enabling voltage sources”) and a plurality of data drivers 154 (also referred to as “data voltage sources”). The scan drivers 152 apply write enabling voltages to scan-line interconnects 110. The data drivers 154 apply data voltages to the data interconnects 112. In some embodiments of the display apparatus, the data drivers 154 are configured to provide analog data voltages to the light modulators, especially where the gray scale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or gray scales in the image 104.

In other cases the data drivers 154 are configured to apply only a reduced set of 2, 3, or 4 digital voltage levels to the control matrix. These voltage levels are designed to set, in digital fashion, either an open state or a closed state to each of the shutters 108.

The scan drivers 152 and the data drivers 154 are connected to digital controller circuit 156 (also referred to as the “controller 156”). The controller 156 includes an input processing module 158, which processes an incoming image signal 157 into a digital image format appropriate to the spatial addressing and the gray scale capabilities of the display 100. The pixel location and gray scale data of each image is stored in a frame buffer 159 so that the data can be fed out as needed to the data drivers 154. The data is sent to the data drivers 154 in mostly serial fashion, organized in predetermined sequences grouped by rows and by image frames. The data drivers 154 can include series to parallel data converters, level shifting, and for some applications digital to analog voltage converters.

The display 100 apparatus optionally includes a set of common drivers 153, also referred to as common voltage sources. In some embodiments the common drivers 153 provide a DC common potential to all light modulators within the array of light modulators 103, for instance by supplying voltage to a series of common interconnects 114. In other embodiments the common drivers 153, following commands from the controller 156, issue voltage pulses or signals to the array of light modulators 103, for instance global actuation pulses which are capable of driving and/or initiating simultaneous actuation of all light modulators in multiple rows and columns of the array 103.

All of the drivers (e.g., scan drivers 152, data drivers 154, and common drivers 153) for different display functions are time-synchronized by a timing-control module 160 in the controller 156. Timing commands from the module 160 coordinate the illumination of red, green and blue and white lamps (162, 164, 166, and 167 respectively) via lamp drivers 168, the write-enabling and sequencing of specific rows within the array of pixels 103, the output of voltages from the data drivers 154, and the output of voltages that provide for light modulator actuation.

The controller 156 determines the sequencing or addressing scheme by which each of the shutters 108 in the array 103 can be re-set to the illumination levels appropriate to a new image 104. Details of suitable addressing, image formation, and gray scale techniques can be found in U.S. patent application Ser. Nos. 11/326,696 and 11/643,042, incorporated herein by reference. New images 104 can be set at periodic intervals. For instance, for video displays, the color images 104 or frames of video are refreshed at frequencies ranging from 10 to 300 Hertz. In some embodiments the setting of an image frame to the array 103 is synchronized with the illumination of the lamps 162, 164, and 166 such that alternate image frames are illuminated with an alternating series of colors, such as red, green, and blue. The image frames for each respective color is referred to as a color sub-frame. In this method, referred to as the field sequential color method, if the color sub-frames are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

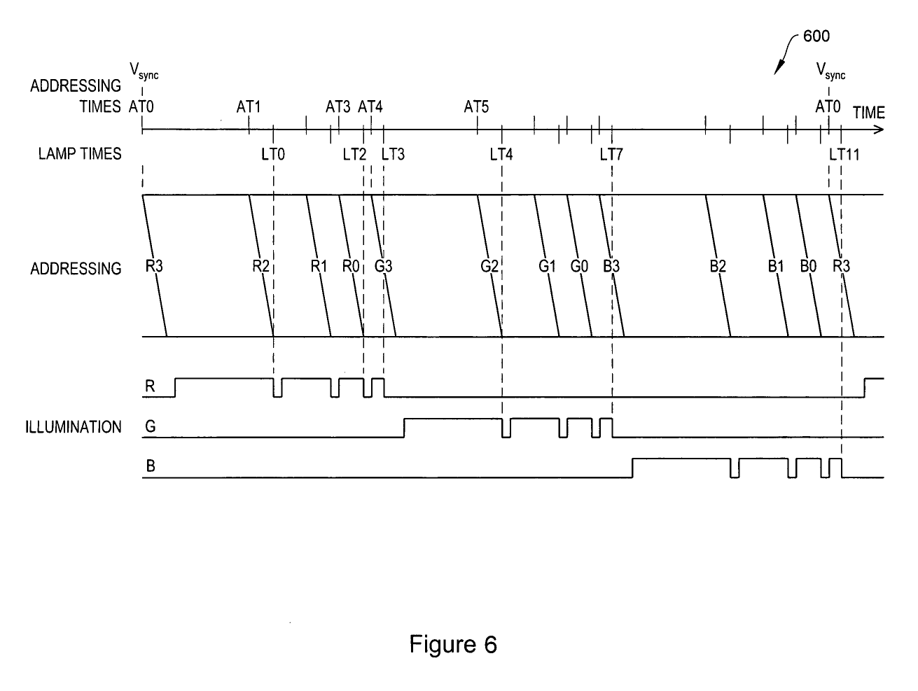

In some implementations, where the display apparatus 100 is designed for the digital switching of shutters 108 between open and closed states, the controller 156 forms an image by the method of time division gray scale. This gray scale method is described further with respect to FIG. 6 below. In other implementations the display apparatus 100 can provide gray scale through the use of multiple shutters 108 per pixel.

In some implementations the data for an image state 104 is loaded by the controller 156 to the modulator array 103 by a sequential addressing of individual rows, also referred to as scan lines. For each row or scan line in the sequence, the scan driver 152 applies a write-enable voltage to the write enable interconnect 110 for that row of the array 103, and subsequently the data driver 154 supplies data voltages, corresponding to desired shutter states, for each column in the selected row. This process repeats until data has been loaded for all rows in the array. In some implementations the sequence of selected rows for data loading is linear, proceeding from top to bottom in the array. In other implementations the sequence of selected rows is pseudo-randomized, in order to minimize visual artifacts. And in other implementations the sequencing is organized by blocks, where, for a block, the data for only a certain fraction of the image state 104 is loaded to the array, for instance by addressing only every 5^{th} row of the array in sequence.

In some implementations, the process for loading image data to the array 103 is separated in time from the process of actuating the shutters 108. In these implementations, the modulator array 103 may include data memory elements for each pixel in the array 103 and the control matrix may include a global actuation interconnect for carrying trigger signals, from common driver 153, to initiate simultaneous actuation of shutters 108 according to data stored in the memory elements. Various addressing sequences, many of which are described in U.S. patent application Ser. No. 11/643,042, can be coordinated by means of the timing control module 160.

In alternative embodiments, the array of pixels 103 and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The display 100 is comprised of a plurality of functional blocks including the timing control module 160, the frame buffer 159, scan drivers 152, data drivers 154, and drivers 153 and 168. Each block can be understood to represent either a distinguishable hardware circuit and/or a module of executable code. In some implementations the functional blocks are provided as distinct chips or circuits connected together by means of circuit boards and/or cables. Alternately, many of these circuits can be fabricated along with the pixel array 103 on the same substrate of glass or plastic. In other implementations, multiple circuits, drivers, processors, and/or control functions from block diagram 150 may be integrated together within a single silicon chip, which is then bonded directly to the transparent substrate holding pixel array 103.

The controller 156 includes a programming link 180 by which the addressing, color, and/or gray scale algorithms, which are implemented within controller 156, can be altered according to the needs of particular applications. In some embodiments, the programming link 180 conveys information from environmental sensors, such as ambient light or temperature sensors, so that the controller 156 can adjust imaging modes or backlight power in correspondence with environmental conditions. The controller 156 also comprises a power supply input 182 which provides the power needed for lamps as well as light modulator actuation. Where necessary, the drivers 152 153, 154, and/or 168 may include or be associated with DC-DC converters for transforming an input voltage at 182 into various voltages sufficient for the actuation of shutters 108 or illumination of the lamps, such as lamps 162, 164, 166, and 167.

### MEMS Light Modulators

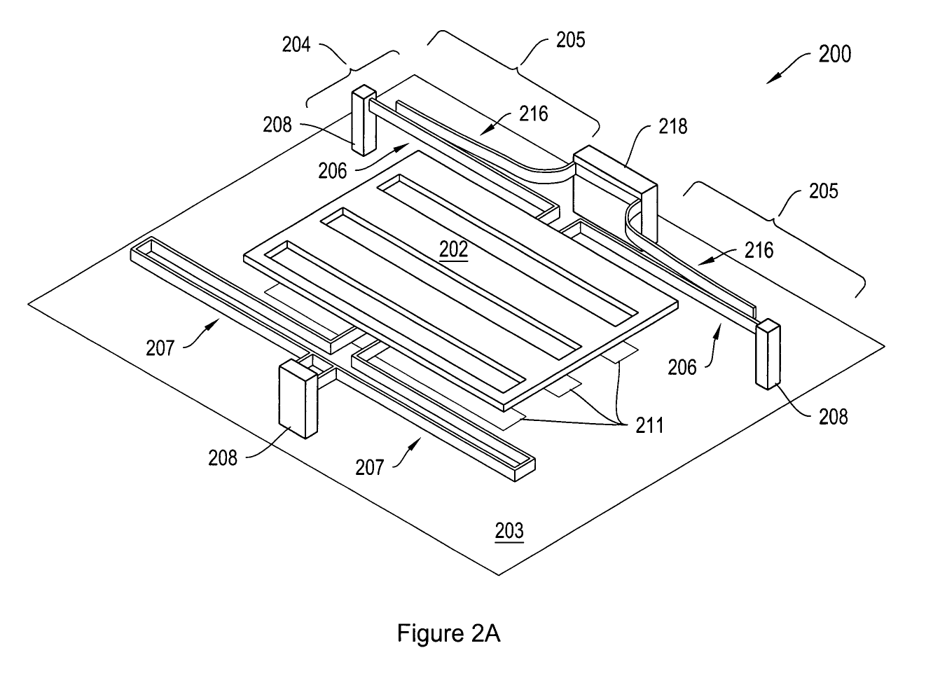

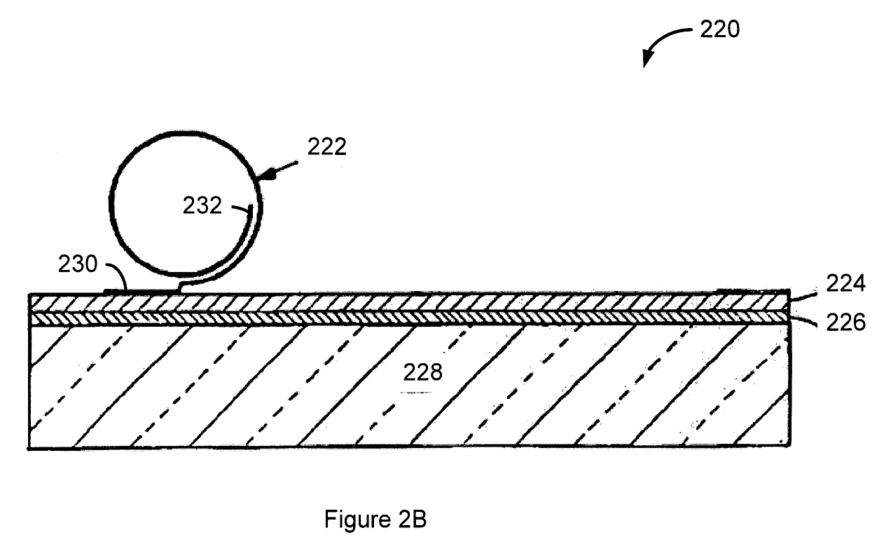

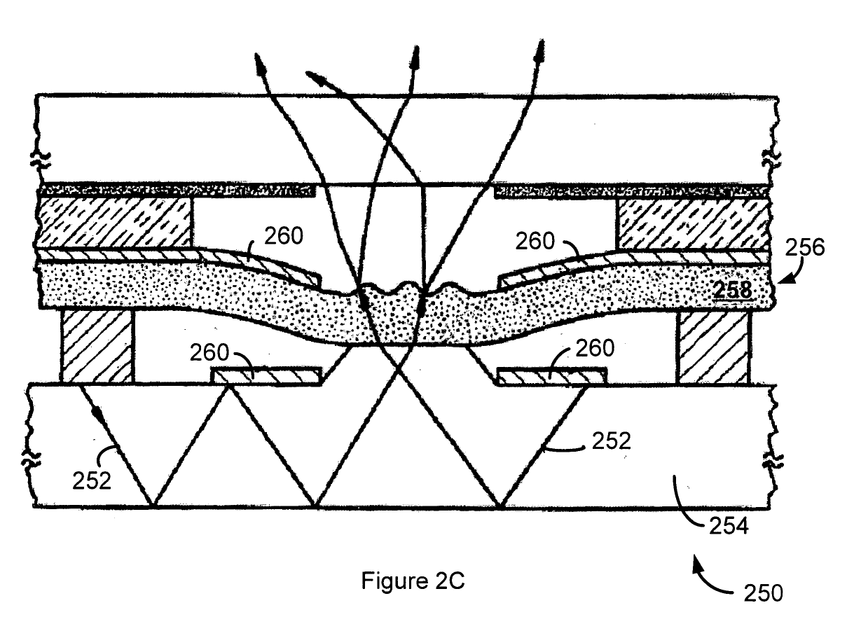

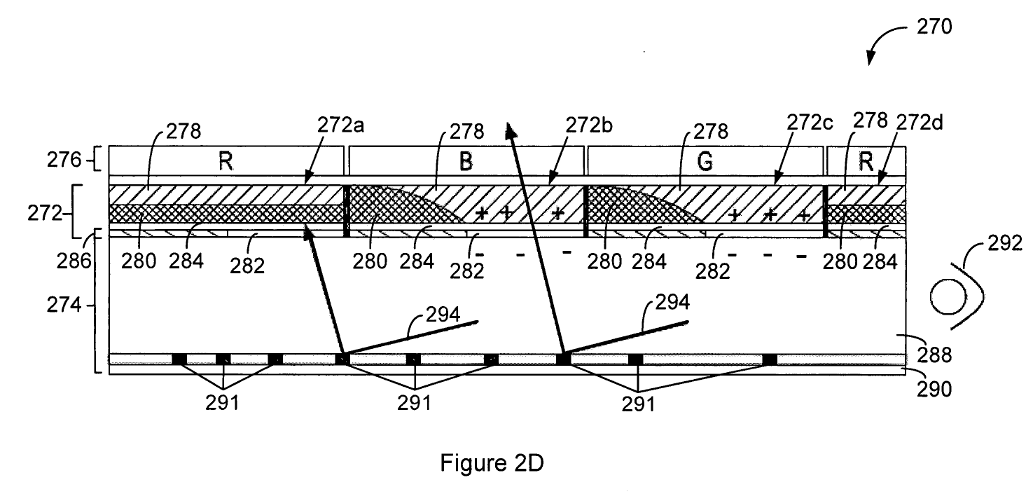

FIG. 2A is a perspective view of an illustrative shutter-based light modulator 200 suitable for incorporation into the MEMS-based display apparatus 100 of FIG. 1A, according to an illustrative embodiment of the invention. The shutter-based light modulator 200 (also referred to as shutter assembly 200) includes a shutter 202 coupled to an actuator 204. The actuator 204 is formed from two separate compliant electrode beam actuators 205 (the “actuators 205”), as described in U.S. patent application Ser. No. 11/251,035, filed on Oct. 14, 2005. The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The load anchors 208 physically connect the compliant load beams 206 and the shutter 202 to the surface 203 and electrically connect the load beams 206 to a bias voltage, in some instances, ground.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

The surface 203 includes one or more apertures 211 for admitting the passage of light. If the shutter assembly 200 is formed on an opaque substrate, made for example from silicon, then the surface 203 is a surface of the substrate, and the apertures 211 are formed by etching an array of holes through the substrate. If the shutter assembly 200 is formed on a transparent substrate, made for example of glass or plastic, then the surface 203 is a surface of a light blocking layer deposited on the substrate, and the apertures are formed by etching the surface 203 into an array of holes 211. The apertures 211 can be generally circular, elliptical, polygonal, serpentine, or irregular in shape.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 is removed, the load beams 206 push the shutter 202 back into its initial position, releasing the stress stored in the load beams 206.

The shutter assembly 200, also referred to as an elastic shutter assembly, incorporates a passive restoring force, such as a spring, for returning a shutter to its rest or relaxed position after voltages have been removed. A number of elastic restore mechanisms and various electrostatic couplings can be designed into or in conjunction with electrostatic actuators, the compliant beams illustrated in shutter assembly 200 being just one example. Other examples are described in U.S. patent application Ser. Nos. 11/251,035 and 11/326,696, incorporated herein by reference. For instance, a highly non-linear voltage-displacement response can be provided which favors an abrupt transition between “open” vs “closed” states of operation, and which, in many cases, provides a bi-stable or hysteretic operating characteristic for the shutter assembly. Other electrostatic actuators can be designed with more incremental voltage-displacement responses and with considerably reduced hysteresis, as may be preferred for analog gray scale operation.

The actuator 205 within the elastic shutter assembly is said to operate between a closed or actuated position and a relaxed position. The designer, however, can choose to place apertures 211 such that shutter assembly 200 is in either the “open” state, i.e. passing light, or in the “closed” state, i.e. blocking light, whenever actuator 205 is in its relaxed position. For illustrative purposes, it is assumed below that elastic shutter assemblies described herein are designed to be open in their relaxed state.

In many cases it is preferable to provide a dual set of “open” and “closed” actuators as part of a shutter assembly so that the control electronics are capable of electrostatically driving the shutters into each of the open and closed states.

Display apparatus 100, in alternative embodiments, includes light modulators other than transverse shutter-based light modulators, such as the shutter assembly 200 described above. For example, FIG. 2B is a cross-sectional view of a rolling actuator shutter-based light modulator 220 suitable for incorporation into an alternative embodiment of the MEMS-based display apparatus 100 of FIG. 1A, according to an illustrative embodiment of the invention. As described further in U.S. Pat. No. 5,233,459, entitled “Electric Display Device,” and U.S. Pat. No. 5,784,189, entitled “Spatial Light Modulator,” the entireties of which are incorporated herein by reference, a rolling actuator-based light modulator includes a moveable electrode disposed opposite a fixed electrode and biased to move in a preferred direction to produce a shutter upon application of an electric field. In one embodiment, the light modulator 220 includes a planar electrode 226 disposed between a substrate 228 and an insulating layer 224 and a moveable electrode 222 having a fixed end 230 attached to the insulating layer 224. In the absence of any applied voltage, a moveable end 232 of the moveable electrode 222 is free to roll towards the fixed end 230 to produce a rolled state. Application of a voltage between the electrodes 222 and 226 causes the moveable electrode 222 to unroll and lie flat against the insulating layer 224, whereby it acts as a shutter that blocks light traveling through the substrate 228. The moveable electrode 222 returns to the rolled state by means of an elastic restoring force after the voltage is removed. The bias towards a rolled state may be achieved by manufacturing the moveable electrode 222 to include an anisotropic stress state.

FIG. 2C is a cross-sectional view of an illustrative non shutter-based MEMS light modulator 250. The light tap modulator 250 is suitable for incorporation into an alternative embodiment of the MEMS-based display apparatus 100 of FIG. 1A, according to an illustrative embodiment of the invention. As described further in U.S. Pat. No. 5,771,321, entitled “Micromechanical Optical Switch and Flat Panel Display,” the entirety of which is incorporated herein by reference, a light tap works according to a principle of frustrated total internal reflection. That is, light 252 is introduced into a light guide 254, in which, without interference, light 252 is for the most part unable to escape the light guide 254 through its front or rear surfaces due to total internal reflection. The light tap 250 includes a tap element 256 that has a sufficiently high index of refraction that, in response to the tap element 256 contacting the light guide 254, light 252 impinging on the surface of the light guide 254 adjacent the tap element 256 escapes the light guide 254 through the tap element 256 towards a viewer, thereby contributing to the formation of an image.

In one embodiment, the tap element 256 is formed as part of beam 258 of flexible, transparent material. Electrodes 260 coat portions of one side of the beam 258. Opposing electrodes 260 are disposed on the light guide 254. By applying a voltage across the electrodes 260, the position of the tap element 256 relative to the light guide 254 can be controlled to selectively extract light 252 from the light guide 254.

FIG. 2D is a cross sectional view of a second illustrative non-shutter-based MEMS light modulator suitable for inclusion in various embodiments of the invention. Specifically, FIG. 2D is a cross sectional view of an electrowetting-based light modulation array 270. The electrowetting-based light modulator array 270 is suitable for incorporation into an alternative embodiment of the MEMS-based display apparatus 100 of FIG. 1A, according to an illustrative embodiment of the invention. The light modulation array 270 includes a plurality of electrowetting-based light modulation cells 272a-272d (generally “cells 272”) formed on an optical cavity 274. The light modulation array 270 also includes a set of color filters 276 corresponding to the cells 272.

Each cell 272 includes a layer of water (or other transparent conductive or polar fluid) 278, a layer of light absorbing oil 280, a transparent electrode 282 (made, for example, from indium-tin oxide) and an insulating layer 284 positioned between the layer of light absorbing oil 280 and the transparent electrode 282. Illustrative implementations of such cells are described further in U.S. Patent Application Publication No. 2005/0104804, published May 19, 2005 and entitled “Display Device.” In the embodiment described herein, the electrode takes up a portion of a rear surface of a cell 272.

The light modulation array 270 also includes a light guide 288 and one or more light sources 292 which inject light 294 into the light guide 288. A series of light redirectors 291 are formed on the rear surface of the light guide, proximate a front facing reflective layer 290. The light redirectors 291 may be either diffuse or specular reflectors. The modulation array 270 includes an aperture layer 286 which is patterned into a series of apertures, one aperture for each of the cells 272, to allow light rays 294 to pass through the cells 272 and toward the viewer.

In one embodiment the aperture layer 286 is comprised of a light absorbing material to block the passage of light except through the patterned apertures. In another embodiment the aperture layer 286 is comprised of a reflective material which reflects light not passing through the surface apertures back towards the rear of the light guide 288. After returning to the light guide, the reflected light can be further recycled by the front facing reflective layer 290.

In operation, application of a voltage to the electrode 282 of a cell causes the light absorbing oil 280 in the cell to move into or collect in one portion of the cell 272. As a result, the light absorbing oil 280 no longer obstructs the passage of light through the aperture formed in the reflective aperture layer 286 (see, for example, cells 272b and 272c). Light escaping the light guide 288 at the aperture is then able to escape through the cell and through a corresponding color (for example, red, green, or blue) filter in the set of color filters 276 to form a color pixel in an image. When the electrode 282 is grounded, the light absorbing oil 280 returns to its previous position (as in cell 272a) and covers the aperture in the reflective aperture layer 286, absorbing any light 294 attempting to pass through it.

The roller-based light modulator 220, light tap 250, and electrowetting-based light modulation array 270 are not the only examples of MEMS light modulators suitable for inclusion in various embodiments of the invention. It will be understood that other MEMS light modulators can exist and can be usefully incorporated into the invention.

U.S. patent application Ser. Nos. 11/251,035 and 11/326,696 have described a variety of methods by which an array of shutters can be controlled via a control matrix to produce images, in many cases moving images, with appropriate gray scale. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve either the speed, the gray scale and/or the power dissipation performance of the display.

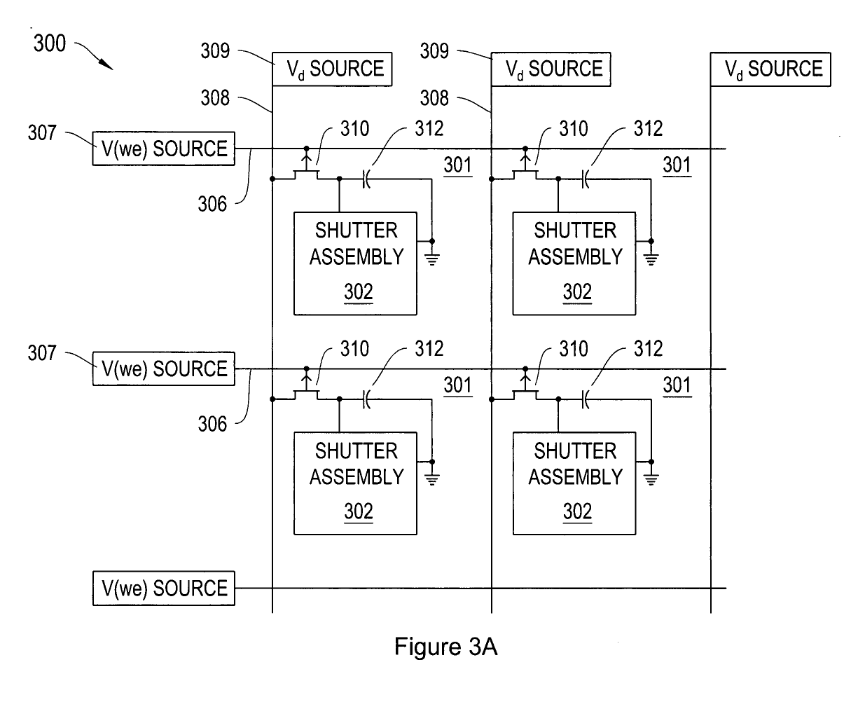

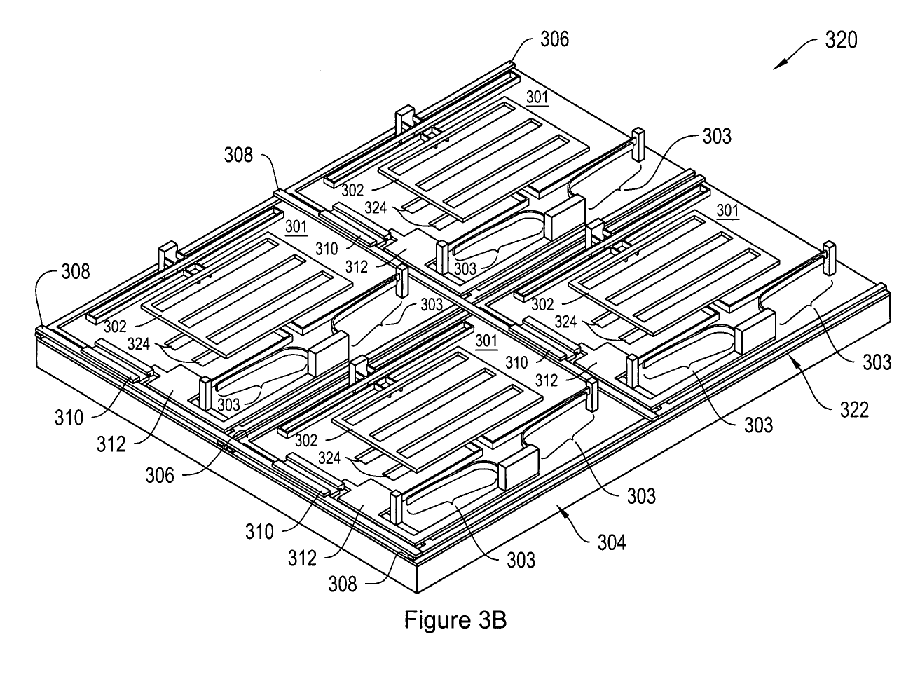

FIG. 3A is a schematic diagram of a control matrix 300 suitable for controlling the light modulators incorporated into the MEMS-based display apparatus 100 of FIG. 1A, according to an illustrative embodiment of the invention. FIG. 3B is a perspective view of an array 320 of shutter-based light modulators connected to the control matrix 300 of FIG. 3A, according to an illustrative embodiment of the invention. The control matrix 300 may address an array of pixels 320 (the “array 320”). Each pixel 301 includes an elastic shutter assembly 302, such as the shutter assembly 200 of FIG. 2A, controlled by an actuator 303. Each pixel also includes an aperture layer 322 that includes apertures 324. Further electrical and mechanical descriptions of shutter assemblies such as shutter assembly 302, and variations thereon, can be found in U.S. patent application Ser. Nos. 11/251,035 and 11/326,696. Descriptions of alternate control matrices can also be found in U.S. patent application Ser. No. 11/607,715.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source, (“Vd source”) 309 to the pixels 301 in a corresponding column of pixels 301. In control matrix 300, the data voltage V_{d} provides the majority of the energy necessary for actuation of the shutter assemblies 302. Thus, the data voltage source 309 also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly 302 actuates, opening the shutter in that shutter assembly 302. The voltage applied to the data interconnect 308 remains stored in the capacitor 312 of the pixel 301 even after the control matrix 300 ceases to apply V_{we} to a row. It is not necessary, therefore, to wait and hold the voltage V_{we} on a row for times long enough for the shutter assembly 302 to actuate; such actuation can proceed after the write-enabling voltage has been removed from the row. The capacitors 312 also function as memory elements within the array 320, storing actuation instructions for periods as long as is necessary for the illumination of an image frame.

The pixels 301 as well as the control matrix 300 of the array 320 are formed on a substrate 304. The array includes an aperture layer 322, disposed on the substrate 304, which includes a set of apertures 324 for respective pixels 301 in the array 320. The apertures 324 are aligned with the shutter assemblies 302 in each pixel. In one implementation the substrate 304 is made of a transparent material, such as glass or plastic. In another implementation the substrate 304 is made of an opaque material, but in which holes are etched to form the apertures 324.

Components of shutter assemblies 302 are processed either at the same time as the control matrix 300 or in subsequent processing steps on the same substrate. The electrical components in control matrix 300 are fabricated using many thin film techniques in common with the manufacture of thin film transistor arrays for liquid crystal displays. Available techniques are described in Den Boer, Active Matrix Liquid Crystal Displays (Elsevier, Amsterdam, 2005), incorporated herein by reference. The shutter assemblies are fabricated using techniques similar to the art of micromachining or from the manufacture of micromechanical (i.e., MEMS) devices. Many applicable thin film MEMS techniques are described in Rai-Choudhury, ed., Handbook of Microlithography, Micromachining & Microfabrication (SPIE Optical Engineering Press, Bellingham, Wash. 1997), incorporated herein by reference. Fabrication techniques specific to MEMS light modulators formed on glass substrates can be found in U.S. patent application Ser. Nos. 11/361,785 and 11/731,628, incorporated herein by reference. For instance, as described in those applications, the shutter assembly 302 can be formed from thin films of amorphous silicon, deposited by a chemical vapor deposition process.

The shutter assembly 302 together with the actuator 303 can be made bi-stable. That is, the shutters can exist in at least two equilibrium positions (e.g. open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 can also be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as spring 207 in shutter-based light modulator 200, or the opposing force may be exerted by an opposing actuator, such as an “open” or “closed” actuator.

The light modulator array 320 is depicted as having a single MEMS light modulator per pixel. Other embodiments are possible in which multiple MEMS light modulators are provided in each pixel, thereby providing the possibility of more than just binary “on’ or “off” optical states in each pixel. Certain forms of coded area division gray scale are possible where multiple MEMS light modulators in the pixel are provided, and where apertures 324, which are associated with each of the light modulators, have unequal areas.

In other embodiments the roller-based light modulator 220, the light tap 250, or the electrowetting-based light modulation array 270, as well as other MEMS-based light modulators, can be substituted for the shutter assembly 302 within the light modulator array 320.

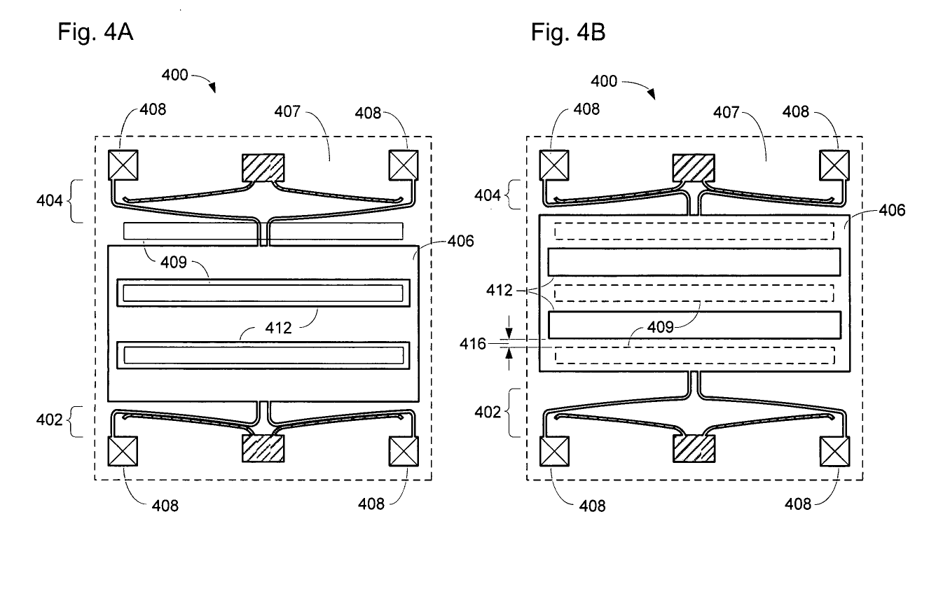

FIGS. 4A and 4B illustrate an alternative shutter-based light modulator (shutter assembly) 400 suitable for inclusion in various embodiments of the invention. The light modulator 400 is an example of a dual actuator shutter assembly, and is shown in FIG. 4A in an open state. FIG. 4B is a view of the dual actuator shutter assembly 400 in a closed state. Shutter assembly 400 is described in further detail in U.S. patent application Ser. No. 11/251,035, referenced above. In contrast to the shutter assembly 200, shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of apertures 412 and 409 coincide. In FIG. 4B the shutter assembly 400 has been moved to the closed state and, as such, the shutter-open actuator 402 is in its relaxed position, the shutter-close actuator 404 has been actuated, and the light blocking portions of shutter 406 are now in position to block transmission of light through the apertures 409 (shown as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In other implementations the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ. A number of control matrices which take advantage of the bi-stable operation characteristic are described in U.S. patent application Ser. No. 11/607,715, referenced above.

### Sensor Based Illumination Control

In order to control illumination and color mixing in a field sequential display, systems are now described that comprise a plurality of lamps, a sensor for detecting information indicative of light from the lamp, and control circuitry for controlling illumination values of the lamp. Feedback circuits will be described that receive information from the sensor and adjust illumination values of the lamp in response to readings from the sensor. It is useful when the control circuitry includes multiple methods by which illumination values are adjusted in the lamps.

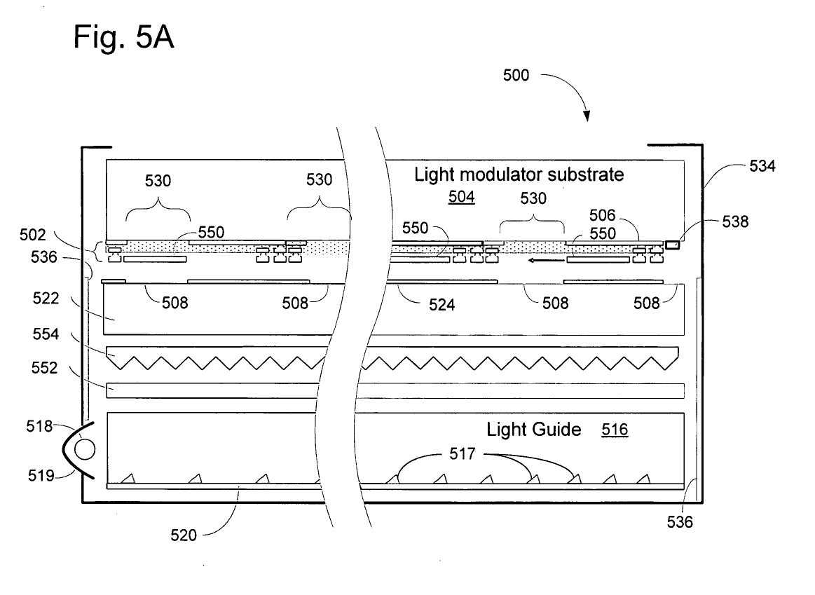

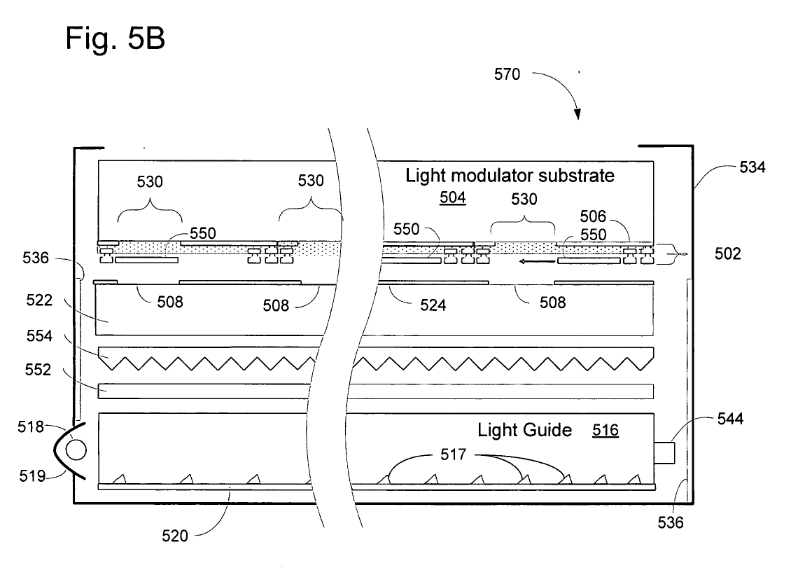

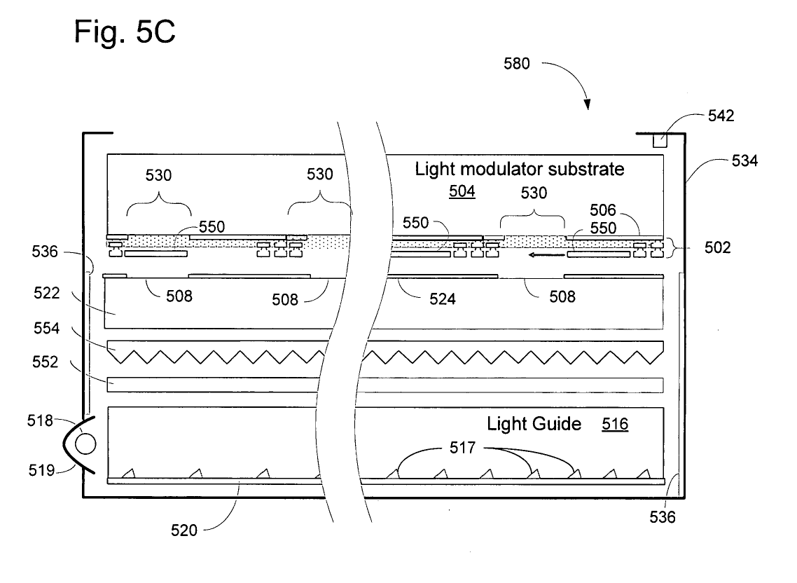

FIGS. 5A, 5B, and 5C are cross sectional views of a display assemblies 500, 570, and 580, each including a photosensor, according to illustrative embodiments of the invention. The display assembly 500 features a light guide 516, a reflective aperture layer 524, and a set of shutter assemblies 502, all of which are built onto separate substrates. Turning to FIG. 5A, the shutter assemblies 502 and the photosensor 538 are built onto substrate 504 and positioned such that they are faced directly opposite to the reflective aperture layer 524.

The shutter assemblies 502 in FIG. 5A include shutters 550 that move horizontally in the plane of the substrate. In other embodiments, the shutters can rotate or move in a plane transverse to the substrate. In other embodiments, a pair of fluids can be disposed in the same position as shutter assemblies 502 where they can function as electrowetting modulators. In other embodiments, a series of light taps which provide a mechanism for controlled frustrated total internal reflection can be utilized in place of shutter assemblies 502.

The vertical distance between the shutter assemblies 502 and the reflective aperture layer 524 is less than about 0.5 mm. In an alternative embodiment the distance between the shutter assemblies 502 and the reflective aperture layer 524 is greater than 0.5 mm, but is still smaller than the display pitch. The display pitch is defined as the distance between pixels (measured center to center), and in many cases is established as the distance between apertures 508 in the rear-facing reflective layer 524. When the distance between the shutter assemblies 502 and the reflective aperture layer 524 is less than the display pitch a larger fraction of the light that passes through the apertures 508 will be intercepted by their corresponding shutter assemblies 502 and the photosensor 538.

Display assembly 500 includes a light guide 516, which is illuminated by one or more lamps 518. The lamps 518 can be, for example, and without limitation, incandescent lamps, fluorescent lamps, lasers, or light emitting diodes (LEDs). In one embodiment, the lamps 518 include LEDs of various colors (e.g., a red LED, a green LED, and a blue LED), which may be alternately illuminated to implement field sequential color.

In addition to red, green, and blue, several 4-color combinations of colored lamps 518 are possible, for instance the combination of red, green, blue, and white or the combination of red, green, blue, and yellow. Some lamp combinations are chosen to expand the space or gamut of reproducible colors. A useful 4-color lamp combination with expanded color gamut is red, blue, true green (about 520 nm), and parrot green (about 550 nm). One 5-color combination which expands the color gamut is red, green, blue, cyan, and yellow. A 5-color lamp combination analogue to the well-known YIQ color space can be established with the lamp colors white, orange, blue, purple, and green. A 5-color lamp combination analogue to the well-known YUV color space can be established with the lamp colors white, blue, yellow, red, and cyan. Other lamp combinations are possible. For instance, a useful 6-color space can be established with the lamp colors red, green, blue, cyan, magenta, and yellow. An alternate combination is white, cyan, magenta, yellow, orange, and green. Combinations of up to 8 or more different colored lamps may be used using the colors listed above, or employing alternate colors whose spectra lie in between the colors listed above.

The lamp assembly includes a light reflector or collimator 519 for introducing a cone of light from the lamp into the light guide within a predetermined range of angles. The light guide includes a set of geometrical extraction structures or deflectors 517 which serve to re-direct light out of the light guide and along the vertical or z-axis of the display. The density of deflectors 517 varies with distance from the lamp 518.

The display assembly 500 includes a front-facing reflective layer 520, which is positioned behind the light guide 516. In display assembly 500, the front-facing reflective layer 520 is deposited directly onto the back surface of the light guide 516. In other implementations the back reflective layer 520 is separated from the light guide by an air gap. The back reflective layer 520 is oriented in a plane substantially parallel to that of the reflective aperture layer 524.

Interposed between the light guide 516 and the shutter assemblies 502 is an optional diffuser 5552 and an optional turning film 5554. Also interposed between the light guide 516 and the shutter assemblies 502 is an aperture plate 522. Disposed on the top surface of the aperture plate 522 is the reflective aperture or rear-facing reflective layer 524. The reflective layer 524 defines a plurality of surface apertures 508, each one located directly beneath the closed position of one of the shutters 550 of shutter assemblies 502.

An optical cavity is formed by the reflection of light between the rear-facing reflective layer 524 and the front-facing reflective layer 520. Light originating from the lamps 518 may escape from the optical cavity through the apertures 508 to the shutter assemblies 502, which are controlled to selectively block the light using shutters 550 to form images. Light that does not escape through an aperture 508 is returned by reflective layer 524 to the light guide 516 for recycling. Light that passes through apertures 508 may also strike the photosensor 538, which measures the brightness or intensity of the light for the purposes of maintaining image and color quality. The photosensor 538 may also be disposed to detect ambient light which reaches it through the light modulator substrate 504 for the purposes of adapting lamp illumination levels. Generally, brighter ambient light requires brighter images to be displayed by the display apparatus 500, and therefore requires greater drive currents or voltages to be applied to the lamps 518.

The aperture plate 522 can be formed from either glass or plastic. To form the rear-facing reflective layer 524, a metal layer or thin film can be deposited onto the aperture plate 522. Suitable highly reflective metal layers include fine-grained metal films without or with limited inclusions formed by a number of vapor deposition techniques including sputtering, evaporation, ion plating, laser ablation, or chemical vapor deposition. Metals that are effective for this reflective application include, without limitation, Al, Cr, Au, Ag, Cu, Ni, Ta, Ti, Nd, Nb, Si, Mo and/or alloys thereof. After deposition, the metal layer can be patterned by any of a number of photolithography and etching techniques known in the microfabrication art to define the array of apertures 508.

In another implementation, the rear-facing reflective layer 524 can be formed from a mirror, such as a dielectric mirror. A dielectric mirror is fabricated as a stack of dielectric thin films which alternate between materials of high and low refractive index. A portion of the incident light is reflected from each interface where the refractive index changes. By controlling the thickness of the dielectric layers to some fixed fraction or multiple of the wavelength and by adding reflections from multiple parallel dielectric interfaces (in some cases more than 6), it is possible to produce a net reflective surface having a reflectivity exceeding 98%. Hybrid reflectors can also be employed, which include one or more dielectric layers in combination a metal reflective layer.

The substrate 504 forms the front of the display assembly 500. A low reflectivity film 506, disposed on the substrate 504, defines a plurality of surface apertures 530 located between the shutter assemblies 502 and the substrate 504. The materials chosen for the film 506 are designed to minimize reflections of ambient light and therefore increase the contrast of the display. In some embodiments the film 506 is comprised of low reflectivity metals such as W or W—Ti alloys. In other embodiments the film 506 is made of light absorptive materials or a dielectric film stack which is designed to reflect less than 20% of the incident light.

Additional optical films can be placed on the outer surface of substrate 504, i.e. on the surface closest to the viewer. For instance the inclusion of circular polarizers or thin film notch filters (which allow the passage of light in the wavelengths of the lamps 518) on this outer surface can further decrease the reflectance of ambient light without otherwise degrading the luminance of the display.

A sheet metal or molded plastic assembly bracket 534 holds the aperture plate 522, shutter assemblies 502, the substrate 504, the light guide 516 and the other component parts together around the edges. The assembly bracket 532 is fastened with screws or indent tabs to add rigidity to the combined display assembly 500. In some implementations, the light source 518 is molded in place by an epoxy potting compound.

The assembly bracket includes side-facing reflective films 536 positioned close to the edges or sides of the light guide 516 and aperture plate 522. These reflective films reduce light leakage in the optical cavity by returning any light that is emitted out the sides of either the light guide or the aperture plate back into the optical cavity. The distance between the sides of the light guide and the side-facing reflective films is preferably less than about 0.5 mm, more preferably less than about 0.1 mm.

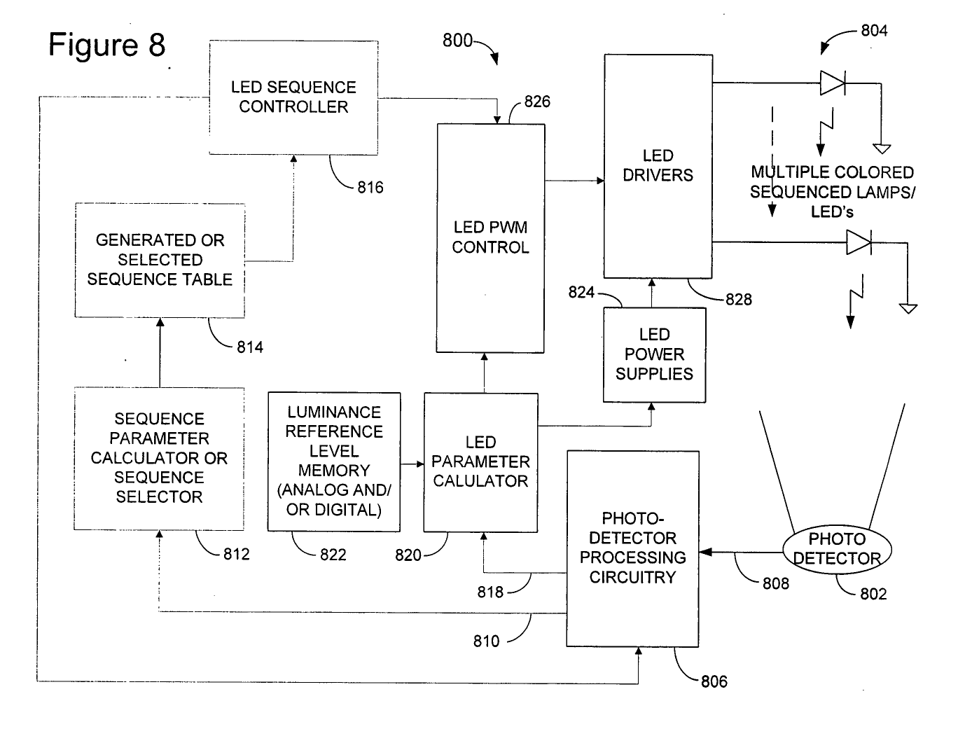

The photosensor 538 in FIG. 5A is built directly onto the light modulator substrate 504, on the side of the substrate 504 that faces directly opposite to the reflective aperture layer 524. (In an alternate embodiment, a photosensor can be placed on the front face of substrate 504, i.e. the side that faces the viewer.) The photosensor 538 may be a discrete component that is soldered in place on substrate 504. The photosensor 538 may employ thin film interconnects which are deposited and patterned on the substrate 504, or it may comprise its own wiring harness for connection to photodetector processing circuitry 806 (shown in block diagram 800 of FIG. 8). If mounted as a discrete component, the photosensor 538 can be packaged such that light can enter the active region of the sensor from two directions: i.e. either from light that originates from the light guide 516 or from the ambient, i.e. from the direction of the viewer. Alternately, the photosensor 538 can be formed from thin film components which are formed at the same time on substrate 504, using similar processes as used with the shutter assemblies 502. In one implementation, the photosensor 538 can be formed from a structure similar to that used for thin film transistors employed in an active matrix control matrix formed on the light modulator substrate 504, i.e. it can be formed from either amorphous or polycrystalline silicon. Suitable photosensors utilizing thin films, such as amorphous silicon, are known in the art, for example, for use in wide-area x-ray imagers.

In an alternative embodiment, the photosensor can be attached to the light guide, as is shown in display assembly 570 in FIG. 5B. The photosensor 544 is attached to the light guide 516. In this position the photosensor 544 receives a strong signal from lamps 518, and yet can still measure indirectly light from the ambient. The photosensor 544 can be molded directly within the plastic material of the light guide 516. Ambient light can reach the light guide 516 after passing through shutter assemblies 502 which are in the open position and through the apertures 508 in the reflective aperture layer 524. The ambient light can then be distributed throughout the light guide so as to impinge on photosensor 544 after scattering off of scattering centers 517 and/or the front-facing reflective layer 520. Although the signal strength for ambient light will be reduced for a photosensor attached to the light guide 516, such a sensor can still be effective at measuring changes to light intensity from the ambient, such as the difference between indoor and outdoor, or between daytime and nighttime lighting levels.

In an alternative embodiment, the photosensor can be attached to the assembly bracket, as is shown in display assembly 580 in FIG. 5C. The photosensor 542 is attached to the assembly bracket 534. The photosensor 542 can be positioned on the assembly bracket either at a position close to the light guide 516, in which case it operates in a fashion similar to the photosensor 544 of FIG. 5B, or it can be positioned on the assembly bracket 534 near the front of the display, as shown in FIG. 5C. The photosensor 542 can be placed on an outside surface of the assembly bracket 534, in which case it receives a strong signal from the ambient but perhaps zero signal from the lamps 518. Preferably the photosensor 542 is positioned as in FIG. 5C such that it can receive light both from the ambient and from the lamps 518. Light from lamps 518 reach the photosensor 542 after traveling through apertures 508 in the reflective aperture layer 524 and through one or more of the open shutters of the shutter assemblies 502. Although the signal strength from lamps 518 will be reduced for a photosensor attached as shown in FIG. 5C, such a sensor can still be effective at measuring changes to light intensity from the lamps 518, such as the differences between emission intensities of separate red, green, and blue lamps, especially as a function of temperature or lifetime.

The photosensors 538, 542, and 544 can be broad-band photosensors, meaning they are sensitive to all light in the visible spectrum, or they can be narrowband. A narrowband sensor can be created, for instance, by placing a color filter in front of the photosensor such that its sensitivity is peaked at only a few wavelengths in the spectrum, for instance at red, or green, or blue wavelengths. In one implementation, photosensors 538, 542, or 544 can represent a group of three or more photosensors, each sensor being a narrowband sensor tuned to a wavelength appropriate to the spectrum of one of the lamps 518. Another narrowband sensor can be provided within the group of sensors 538, or 542, or 544 in which the sensitive band is chosen to correspond to a wavelength which is indicative of the general ambient illumination and relatively insensitive to the wavelengths from any of the lamps 518, for instance it could be sensitive to primarily yellow radiation near 570 nm. In a preferred implementation, described below, only a single broad-band sensor is employed, and timing signals from the field sequential display are employed to help the sensor discriminate between light that originates from the various lamps 518 or from the ambient.

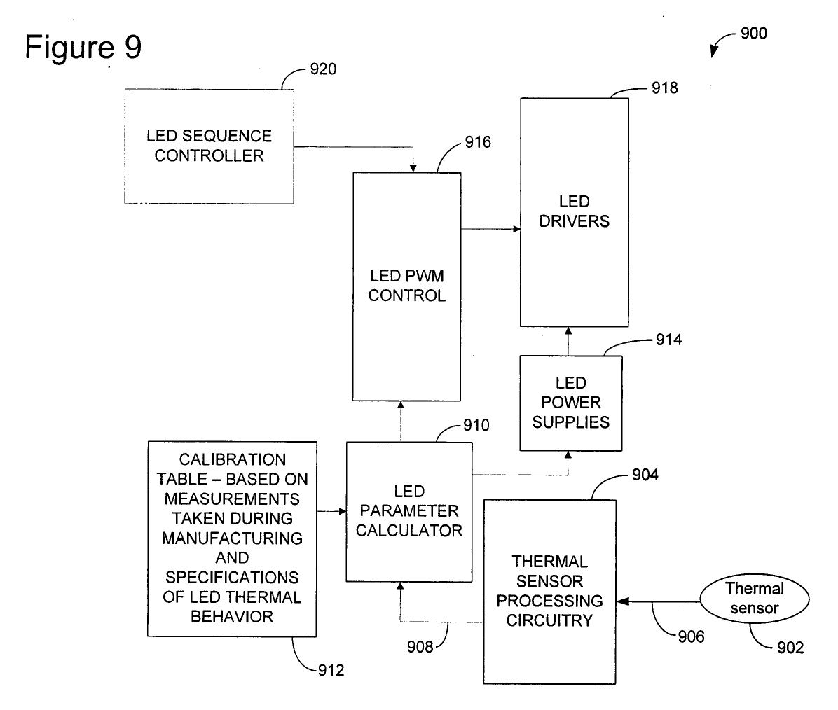

Information from sensors, such as a thermal sensor or photosensor (e.g., the photosensors 538, 542, and 544 depicted in FIGS. 5A-5C), are transmitted to a controller for controlling the illumination of the lamps, thereby implementing either a closed-loop feedback or open-loop control to maintain image quality (e.g., by varying the brightness of the images displayed or altering the balance of colors to improve color quality). FIGS. 8 and 9 depict block diagrams representing exemplary feedback control circuitry based on a photosensor or a thermal sensor, respectively, according to illustrative embodiments of the invention. The feedback circuits in FIGS. 8 and 9 are capable of controlling illumination values in the lamps by means of either or both of pulse width modulation or pulse amplitude modulation.

In some implementations, where display apparatus 100 is designed for the digital switching of shutters 108 between open and closed states, the controller 156 determines the length of time that the shutters remain open in each image frame. The controller 156 also employs the sequencer 160 and the lamp drivers 168 for controlling the length of time over which lamps are illuminated in an image frame. The controller 156 synchronizes the addressing of the shutters with the illumination of the lamps.

The process of generating varying levels of grayscale by controlling the amount of time a shutter 108 is open in a particular frame is referred to as time division gray scale. In one embodiment of time division gray scale, each of the lamps 162, 164, 166, and 167 is illuminated just once within an image frame and the controller 156 determines the fraction of time within each color sub-frame that a pixel is allowed to remain in the open state, according to the gray level desired for that pixel and that primary color in the image frame. In other implementations, for each image frame and for each color, the controller 156 sets a plurality of sub-frame images in multiple rows and columns of the array 103, and the controller alters the duration over which each sub-frame image is illuminated in proportion to a gray scale value or significance value associated with a coded word for gray scale. For instance, the illumination times for a series of sub-frame images can be varied in proportion to the binary coding series 1, 2, 4, 8 . . . . The shutters 108 for each pixel in the array 103 are then set to either the open or closed state within a sub-frame image according to the value at a corresponding position within the pixel's binary coded word for gray level.

FIG. 6 illustrates an example of a timing sequence, referred to as display process 600, employed by controller 156 for the formation of an image using a series of sub-frame images in a binary time division gray scale. The sequencer 160, used with display process 600, is responsible for coordinating multiple operations in the timed sequence (time varies from left to right in FIG. 6). The sequencer 160 determines when data elements of a sub-frame data set are transferred out of the frame buffer 159 and into the data drivers 154. The sequencer 160 also sends trigger signals to enable the scanning of rows in the array 103 by means of scan drivers 152, thereby enabling the loading of data from the data from drivers 154 into the pixels of the array 103. The sequencer 160 also governs the operation of the lamp drivers 168 to enable the illumination of the lamps 162, 164, 166 (the white lamp 167 is not employed in display process 600). The sequencer 160 also sends trigger signals to the common drivers 153 which enable functions such as the global actuation of shutters substantially simultaneously in multiple rows and columns of the array 103.

The process of forming an image in display process 600 comprises, for each sub-frame image, first the loading of a sub-frame data set out of the frame buffer 159 and into the array 103. A sub-frame data set includes information about the desired states of modulators (e.g. open vs closed) in multiple rows and multiple columns of the array. For binary time division gray scale, a separate sub-frame data set is transmitted to the array for each bit level within each color in the binary coded word for gray scale. For the case of binary coding, a sub-frame data set is referred to as a bitplane. (Coded time division schemes using other than binary coding are described in U.S. patent application Ser. No. 11/643,042.) The display process 600 refers to the loading of 4 bitplane data sets in each of the three colors red, green, and blue. These data sets are labeled as R0, R1, R2, and R4 for red, G0-G3 for green, and B0-B3 for blue. For economy of illustration only 4 bit levels per color are illustrated in the display process 600, although it will be understood that alternate image forming sequences are possible that employ 6, 7, 8, or 10 bit levels per color.

The display process 600 refers to a series of addressing times AT0, AT1, AT2, etc. These times represent the beginning times or trigger times for the loading of particular bitplanes into the array 103. The first addressing time AT0 coincides with Vsync, which is a trigger signal commonly employed to denote the beginning of an image frame. The display process 600 also refers to a series of lamp illumination times LT0, LT1, LT2, etc., which are coordinated with the loading of the bitplanes. These lamp triggers indicate the times at which the illumination from one of the lamps 162, 164, 166 is extinguished. The illumination pulse periods and amplitudes for each of the red, green, and blue lamps are illustrated along the bottom of FIG. 6, and labeled along separate lines by the letters “R”, “G”, and “B”.

The loading of the first bitplane R3 commences at the trigger point AT0. The second bitplane to be loaded, R2, commences at the trigger point AT1. The loading of each bitplane requires a substantial amount of time. For instance the addressing sequence for bitplane R2 commences in this illustration at AT1 and ends at the point LT0. The addressing or data loading operation for each bitplane is illustrated as a diagonal line in timing diagram 600. The diagonal line represents a sequential operation in which individual rows of bitplane information are transferred out of the frame buffer 159, one at a time, into the data drivers 154 and from there into the array 103. The loading of data into each row or scan line requires anywhere from 1 microsecond to 100 microseconds. The complete transfer of multiple rows or the transfer of a complete bitplane of data into the array 103 can take anywhere from 100 microseconds to 5 milliseconds, depending on the number of rows in the array.

In display process 600, the process for loading image data to the array 103 is separated in time from the process of moving or actuating the shutters 108. For this implementation, the modulator array 103 includes data memory elements, such as storage capacitor 312, for each pixel in the array 103 and the process of data loading involves only the storing of data (i.e. on-off or open-close instructions) in the memory elements. The shutters 108 do not move until a global actuation signal is generated by one of the common drivers 153. The global actuation signal is not sent by the sequencer 160 until all of the data has been loaded to the array. At the designated time, all of the shutters designated for motion or change of state are caused to move substantially simultaneously by the global actuation signal. A small gap in time is indicated between the end of a bitplane loading sequence and the illumination of a corresponding lamp. This is the time required for global actuation of the shutters. The global actuation time is illustrated, for example, between the trigger points LT2 and AT4. It is preferable that all lamps be extinguished during the global actuation period so as not to confuse the image with illumination of shutters that are only partially closed or open. The amount of time required for global actuation of shutters, such as in shutter assemblies 400, can take, depending on the design and construction of the shutters in the array, anywhere from 10 microseconds to 500 microseconds.

For the example of display process 600 the sequence controller is programmed to illuminate just one of the lamps after the loading of each bitplane, where such illumination is delayed after loading data of the last scan line in the array by an amount of time equal to the global actuation time. Note that loading of data corresponding to a subsequent bitplane can begin and proceed while the lamp remains on, since the loading of data into the memory elements of the array does not immediately affect the position of the shutters.

Each of the sub-frame images, e.g. those associated with bitplanes R3, R2, R1, and R0 is illuminated by a distinct illumination pulse from the red lamp 162, indicated in the “R” line at the bottom of FIG. 6. Similarly, each of the sub-frame images associated with bitplanes G3, G2, G1, and G0 is illuminated by a distinct illumination pulse from the green lamp 164, indicated by the “G” line at the bottom of FIG. 6. The illumination values (for this example the length of the illumination periods) used for each sub-frame image are related in magnitude by the binary series 8, 4, 2, 1, respectively. This binary weighting of the illumination values enables the expression or display of a gray scale coded in binary words, where each bitplane contains the pixel on-off data corresponding to just one of the place values in the binary word. The commands that emanate from the sequence controller 160 ensure not only the coordination of the lamps with the loading of data but also the correct relative illumination period associated with each data bitplane.

A complete image frame is produced in display process 600 between the two subsequent trigger signals Vsync. A complete image frame in display process 600 includes the illumination of 4 bitplanes per color. For a 60 Hz frame rate the time between Vsync signals is 16.6 milliseconds. The time allocated for illumination of the most significant bitplanes (R3, G3, and B3) can be in this example approximately 2.4 milliseconds each. By proportion then, the illumination times for the next bitplanes R2, G2, and B2 would be 1.2 milliseconds. The least significant bitplane illumination periods, R0, G0, and B0, would be 300 microseconds each. If greater bit resolution were to be provided, or more bitplanes desired per color, the illumination periods corresponding to the least significant bitplanes would require even shorter periods, substantially less than 100 microseconds each.

It is useful, in the development or programming of the sequence controller 160, to co-locate or store all of the critical sequencing parameters governing expression of gray scale in a sequence table, sometimes referred to as the sequence table store (and illustrated at circuit block 814 in the control circuit 800). An example of a table representing the stored critical sequence parameters is listed below as Table 1. The sequence table lists, for each of the sub-frames or “fields” a relative addressing time (e.g. AT0, at which the loading of a bitplane begins), the memory location of associated bitplanes to be found in buffer memory 159 (e.g. location M0, Ml, etc.), an identification codes for one of the lamps (e.g. R, G, or B), and a lamp time (e.g. LT0, which in this example determines that time at which the lamp is turned off).

TABLE 1
Sequence Table 1

| | | | | | | | | | Field | |
|---|---|---|---|---|---|---|---|---|---|---|
| | Field 1 | Field 2 | Field 3 | Field 4 | Field 5 | Field 6 | Field 7 | - - - | n − 1 | Field n |
| addressing time | AT0 | AT1 | AT2 | AT3 | AT4 | AT5 | AT6 | - - - | AT(n − 1) | ATn |
| memory location of | M0 | M1 | M2 | M3 | M4 | M4 | M6 | - - - | M(n − 1) | Mn |
| sub-frame data set | | | | | | | | | | |
| lamp ID | R | R | R | R | G | G | G | - - - | B | B |
| lamp time | LT0 | LT1 | LT2 | LT3 | LT4 | LT5 | LT6 | - - - | LT(n − 1) | LTn |

It is useful to co-locate the storage of parameters in the sequence table to facilitate an easy method for re-programming or altering the timing or sequence of events in a display process. For instance it is possible to re-arrange the order of the color sub-fields so that most of the red sub-fields are immediately followed by a green sub-field, and the green are immediately followed by a blue sub-field. Such rearrangement or interspersing of the color subfields increase the nominal frequency at which the illumination is switched between lamp colors, which reduces the impact of a perceptual imaging artifact known as color break-up. By switching between a number of different schedule tables stored in memory, or by re-programming of schedule tables, it is also possible to switch between processes requiring either a lesser or greater number of bitplanes per color—for instance by allowing the illumination of 8 bitplanes per color within the time of a single image frame. It is also possible to easily re-program the timing sequence to allow the inclusion of sub-fields corresponding to a fourth color LED, such as the white lamp 167. An exemplary circuit block for reprogramming of a sequence table is given by block 812 in control circuit 800.

The display process 600 establishes gray scale according to a coded word by associating each sub-frame image with a distinct illumination value based on the pulse width or illumination period in the lamps. Alternate methods are available for expressing illumination value. In one alternative, the illumination periods allocated for each of the sub-frame images are held constant and the amplitude or intensity of the illumination from the lamps is varied between sub-frame images according to the binary ratios 1, 2, 4, 8, etc. For this implementation the format of the sequence table is changed to assign a unique lamp intensity for each of the sub-fields instead of a unique timing signal. In other embodiments of a display process both the variations of pulse duration and pulse amplitude from the lamps are employed and both specified in the sequence table to establish gray scale distinctions between sub-frame images. These and other alternative methods for expressing time domain gray scale using a timing controller are described in co-pending U.S. patent application Ser. No. 11/643,042, filed Dec. 19, 2006, incorporated herein by reference.

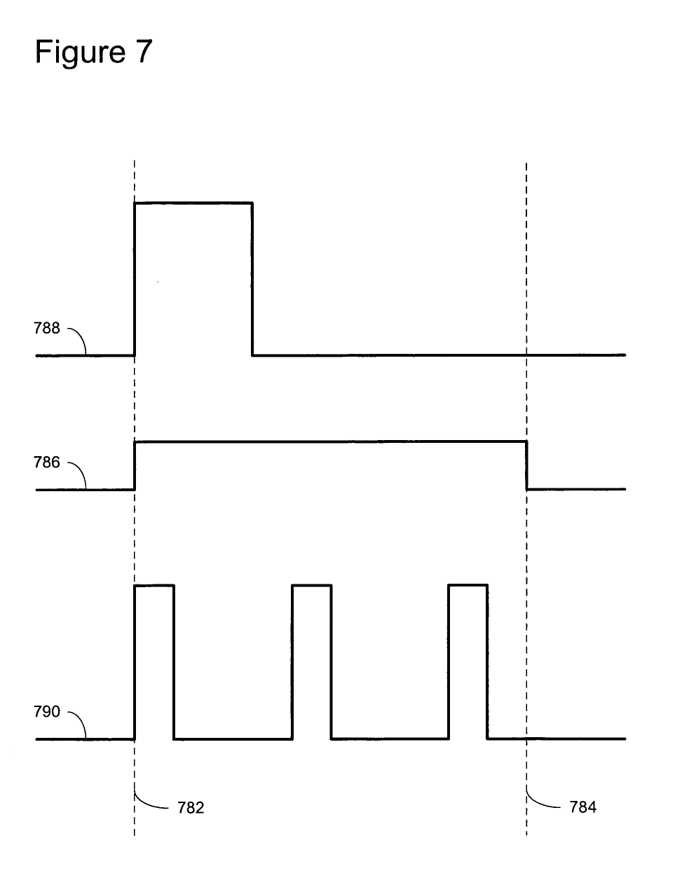

FIG. 7 illustrates different methods available for control of illumination value within a given sub-frame image. In FIG. 7 the time markers 782 and 784 determine time limits within which one or more of the lamps 162, 164, 166, and 167 express their illumination value, as called for within a particular display process and governed by sequencer 160 within controller 156. The lamp pulse 786 is one pulse appropriate to the expression of a particular illumination value. The pulse width 786 completely fills the time available between the trigger times 782 and 784. The intensity or amplitude of lamp pulse 786 is varied according to commands from the sequencer 160 to achieve a required illumination value. An amplitude modulation scheme according to lamp pulse 786 can be useful in cases where lamp efficiencies are not linear and power efficiencies can be improved by reducing the peak intensities required of the lamps. The lamp pulse 788 is a pulse appropriate to the expression of the same illumination value as in lamp pulse 786. The illumination value of pulse 788 is expressed by means of pulse width modulation instead of by amplitude modulation. The integral of the pulse amplitude over time for pulse 788 is equivalent to the same integral for pulse 786. The series of lamp pulses 790 represent another method of expressing the same illumination value as in lamp pulse 786. A series of pulses can express an illumination value through control of both the pulse width and the frequency of the pulses. The illumination value can be considered as the product of the pulse amplitude, the available time period between markers 782 and 784, and the pulse duty cycle.

It is advantageous when a controller is capable of implementing both pulse width modulation (pulses 788 or 790) and pulse amplitude modulation (pulse 786) for the lamps. Different lamp modulations are appropriate in different situations, where the choice can depend in some cases on the available speed and efficiency of the driver circuits and in some cases by the operational characteristics of the lamps. A pulsed or duty-cycle type of modulation signal, expressed by signal 790, can be produced by providing a constant voltage or constant current power supply for a lamp and by interrupting the voltage or current from the power supply by means of a simple on-off switch arranged in a series configuration with the lamp. The pulsed signal 790, by means of variations in duty cycle, can produce precise and high-speed variations to the illumination value. In many situations, however, the power efficiency from an LED is improved by reducing the average drive current to the LED. In these situations it is useful to provide an additional capability for current, voltage, or amplitude modulation to the lamps as shown in the signal 786.

The illumination values supplied by the lamps, such as lamps 162, 164, 166, and 167, are varied in a feedback loop in response to a sensor that detects information indicative of light from the lamp. FIG. 8 illustrates one method of lamp control by beams of feedback control circuitry 800. The feedback control circuit 800 includes an LED sequence controller 816 which incorporates the timing control functions of the sequencer 160 shown in FIG. 1B. The feedback control circuit 800 includes a set of LED power supplies 824 and an LED driver circuit 828, which incorporate the functions of the lamp drivers 168 from FIG. 1B. The LED driver circuit is connected to a series of lamps, for instance LEDs 804. The LED power supplies 824 can be variable voltage or variable current power supplies whose output voltage and/or output current is determined in part by the LED parameter calculator block 820. The LED drivers 828 can comprise a series of switches, in some cases one switch for each of the lamps or LEDs 804. The switches in the LED drivers 828 are used to provide and on/off or pulse width modulation to the power delivered from the LED power supplies 824.

The feedback control circuit 800 includes a photodetector 802 capable of detecting the intensity of light from multiple lamps 804 and/or ambient light from environmental sources external to a display. The closed-loop feedback circuitry 800 is part of a FSC display, in which case the lamps 804 may be LEDs of different colors, such as red, green, and blue, or alternate 4-color combinations that are illuminated alternately in sequence to form color images. Photodetector processing circuitry 806 electronically filters and amplifies a sensor signal 808 from the photodetector 802 to generate outputs representing information contained within the sensor signal 808 and with which the circuitry 800 can modify the illumination of the lamps 804.

In some embodiments, an output 810 from the photodetector processing circuitry 806 is received by circuitry that determines and implements critical sequence parameters which are employed by a display process, such as the time division gray scale process 600. An example of a list of sequence parameters is given in Sequence Table 1 above. This sequence table and/or multiple similar sequence tables is stored in memory at block 814. The output 810 from the photodetector processing circuitry 806 is received by a sequence generator 812 which, based on the output 810, may calculate parameters of a sequence or select a sequence from a number of predetermined sequences to store in sequence table 814. An LED sequence controller 816 employs information from the sequence table 814 to control illumination of the lamps 804 according to values within the sequence table 814 such as timing values for lamp illumination or extinguishing and lamp intensity values. By determining parameters of a sequence table, the sequence generator 812 may adjust the length of time a lamp will be illuminated to display a sub-image, the intensity at which a lamp is illuminated, and/or the number of sub-images shown per image.

The LED sequence controller 816 may also transmit timing information related to the illumination of the lamps to the photodetector processing circuitry 806 so that information in the sensor signal 808 may be identified with a specific lamp or lamp color. For example, the photodetector processing circuitry 806 may determine that a light intensity level detected by the photodetector at a specific point in time corresponds to when the red LED is illuminated according to information sent from the LED sequence controller 816. In another example, the photodetector processing circuitry 806 may determine that a light intensity level detected by the photodetector at a specific point in time corresponds to when no lamps are illuminated according to information sent from the LED sequence controller 816, and therefore corresponds to ambient light. If the brightness of an LED of some particular color is too high or too low relative to the LEDs of other colors and/or the current intensity level of ambient light, the circuitry 800 can correct the brightness via varying the sequences, as described above, and/or LED parameters, as described below.

In some embodiments, an output 818 from the photodetector processing circuitry 806 is received by circuitry that drives the lamps 804, which may be LEDs. In particular, the output 818 is received by an LED parameter calculator 820 which generates parameters related to the illumination of the LEDs based on the output 818 and reference values 822 stored in memory. Parameters determined by the LED parameter calculator 820 are transmitted to LED power supplies 824 and an LED pulse width modulation (PWM) controller 826, each in communication with LED drivers 828 that drive the LEDs 804. In particular, parameters indicating the current and/or voltage supplied to the various LEDs 804 via the LED drivers 828 may be determined by the LED parameter calculator 820.

The luminance reference memory 822 can be a programmable memory. The reference values are preferably determined and stored in memory 822 during a calibration step as part of the manufacturing process of the display. In the calibration process the luminance properties of individual lamps 804 as well as the response properties of the photodetectors 802 are measured, and reference values are then determined such that, for instance, a particular combination of lamp currents and intensities verifiably produces a desired white color point during field sequential operation at room temperature. During operation, as output intensities from the lamps vary based on either temperature or lifetime, the LED parameter calculator 820 can be programmed to adjust either lamp currents, voltages, or pulse widths at lamps 804 from an initial value to whatever value is necessary to re-establish the correct lamp luminance and therefore white point.

The LED power supplies 824 can be switch mode power supplies, whereby a transistor (or transistors) is employed to switch power into or out of storage elements at a particular frequency and duty cycle such that an approximately constant DC current and/or voltage is supplied to the LED drivers 828. The storage elements are disposed on both the load and the supply side of the switch. The storage elements on the load side of the switch can be a capacitor or an inductor connected with the output of power supply 824. The storage elements on the supply side of the switch can comprise at a minimum either a capacitor or an inductor. Resonant supply circuits that employ both capacitors and inductors are possible, and charge pump supply circuits that employ multiple capacitors separated by additional switches are also possible. The output DC current or voltage level, which is controlled by the duty cycle of the switch, can be adjusted in response to commands from the LED parameter calculator 820. A feedback loop, which monitors the current and/or voltage from the power supply 824, can be added to improve the accuracy of the output. In one implementation, the output from the power supply 824 can be fed into a voltage divider such that a fixed fraction of the output can be compared to a reference voltage. The feedback loop then adjusts the duty cycle until the desired average DC output is achieved. In another implementation, the output from power supply 824 can be fed into an analog to digital converter, and a digital comparator can then be used to adjust the output of power supply 824 toward any desired set point or output, based on parameters received from the LED parameter calculator 820.

As was discussed with respect to FIG. 7 above, LED average illumination levels can be adjusted through variations in either amplitude or pulse width. The control circuit 800 provides the ability to adjust either the pulse amplitude (by means of LED power supply 824) or the pulse width (by means of means of the LED PWM controller 826). Adjustments to one or the other of pulse amplitude or pulse width have different advantages which apply in different situations. For instance, many LEDs have a non-linear or saturated current-voltage characteristic and they tend to operate more efficiently at lower current levels. A power savings advantage, therefore, can accrue to the display as a whole if LED pulses are adjusted in amplitude by means of an adjustable power supply, such as the power supplies 824 described above. Adjustments to LED currents achieved by means of a switch mode power supply, however, especially when that power supply is designed to be operated for efficiency and accuracy, can be slow—requiring several milliseconds to take effect. Therefore feedback circuits that affect illumination by means of the LED power supply 824 tend to be preferred in situations where only occasional adjustment is necessary, such as adjustments made in response to LED aging, ambient temperature, or variations in ambient illumination value. In some implementations, in order to reduce circuit cost, a version of LED power supply 824 is provided which is only switchable between a finite number of unique output levels, such as LED powers applicable to one of either indoor or outdoor ambient illumination.

The LED pulse width modulation (PWM) controller 826 is designed to control pulse width, pulse triggering, and optionally pulse frequency within the LED drivers 828. The LED pulse width modulation (PWM) controller 826 controls an on-off output switch within the LED drivers 828, thereby switching the LED voltages or currents between a pre-specified amplitude, for instance that which is output from LED power supply 824, and zero. This switching of LED outputs can be very fast, for instance where transition times can be faster than 10 microseconds, and in many cases faster than 1 microsecond. The PWM controller 826 can therefore provide a precise means for adjusting the average illumination value from the lamps 804 by the pulses described with respect to FIG. 7, and as may be required for use in a time division gray scale process such as display process 600. In display designs where the LED power supply 824 provides only a single fixed DC output power level, or only 2 or 3 separately settable power levels, the LED PWM controller 826 can be used to fine tune the illumination values of the lamps 804.

An improved trade off between response speed and energy efficiency for control of lamps 804 can be accomplished by combining the modulation capability provided by the LED power supplies 824 and by the LED PWM controller 826.

The LED PWM controller 826 receives trigger signals and illumination values from the LED sequence controller 816. For example, the PWM controller 826 can be programmed to output pulses based on a coded word for lamp intensity received from sequence controller 816. The PWM controller 826 can also receive illumination adjustment parameters (based on feedback from the photodetector) through the LED parameter calculator 820. The received sequence parameters may include an illumination value which is defined as the product (or the integral) of an illumination period (or pulse width) with the lamp intensity of that illumination. These illumination values can be determined within the LED sequence controller 816 as those appropriate to the display of particular image data received from the host device. The speed of the LED PWM controller 826 is therefore an advantage when responding to a stream of changing display data, as in video data. In some implementations, the LED sequence controller 816 can respond to inputs from the photo-detector processing circuitry 806, for instance, by adjusting the number of gray levels in the display in response to the ambient illumination level. As described in co-pending U.S. patent application Ser. No. 11/643,042, the sequence parameter calculator 812 can also be programmed to affect rapid changes in the average illumination level of the lamps.

Instead of a photodetector, a thermal sensor may be used to detect information related to the brightness of an LED. FIG. 9 depicts a block diagram representing illustrative open-loop feedback control circuitry 900 based on a thermal sensor 902 capable of detecting an ambient temperature. LEDs of different colors respond differently to changes in temperature. However, changes in intensity as a function of temperature for LEDs of various colors can be predicted reasonably well. As such, the circuitry 900 can modify the illumination of LEDs based on a measured temperature to maintain a desired balance of colors. The thermal sensor can be included within the display module assembly, in locations similar to the photosensors 538, 542, and 544, or the thermal sensors can be included within the casing of the host electronics device.

Thermal sensor processing circuitry 904 processes a sensor signal 906 from the thermal sensor 902 to generate an output 908 representing information contained within the sensor signal 906 and transmitted to circuitry for driving the LEDs. In particular, the output 908 is received by an LED parameter calculator 910 which generates parameters related to the illumination of the LEDs based on the output 908 and reference values from a calibration table 912 stored in memory. For example, the LED parameter calculator 910 may select specific parameters because they are stored in the calibration table 912 in a location corresponding to a specific temperature measured by the thermal sensor 902 and indicated by the output 908.

Parameters determined by the LED parameter calculator 910 are transmitted to LED power supplies 914 and an LED PWM controller 916, each in communication with LED drivers 918 that drive the LEDs. The LED power supplies 914, LED PWM controller 916, and LED drivers 918 are similar to the LED power supplies 824, LED PWM controller 826, and LED drivers 828 of FIG. 8. In particular, parameters indicating the current and/or voltage supplied to the various LEDs via the LED drivers 918 may be determined by the LED parameter calculator 910.

Alternatively or in addition, the LED PWM controller 916 receives sequence values from an LED sequence controller 920, similar to the LED sequence controller 816 of FIG. 8, and parameters relating to the implementation of the sequence values from the LED parameter calculator 910. The received sequence values may include a illumination value. For a given time interval during which a specific sub-image is displayed, there are numerous alternative methods for controlling the lamps to achieve any required illumination value, which are described above with respect to FIG. 7.

The LED PWM controller 916 can implement any of the alternate lamp pulses 786, 788, or 790 of FIG. 7 via the LED drivers 918. For example, the LED PWM controller 916 can be programmed to accept a coded word for lamp intensity from the LED sequence controller 920 and build a sequence of pulses appropriate to intensity. The intensity can be varied as a function of either pulse amplitude or pulse duty cycle.

The feedback circuits 800 and 900 are useful for a wide range of MEMS light modulators, such as light modulators 200, 220, 250, or 270. Similar time division gray scale methods can be utilized in displays that incorporate interference modulation or in displays that incorporate fast liquid crystal modulators, such as ferroelectric or OCB mode liquid crystal displays. The lamp modulation techniques and sensor feedback techniques described above with respect to circuits 800 and 900 are helpful with any of these fast modulation displays.

The feedback circuits 800 and 900 have a utility that is not limited to displays that operate using the methods of time division gray scale. In some implementations, the MEMS or liquid crystal displays are capable of an analog gray scale, in which case a control matrix provides an analog voltage to the actuators in each pixel in correspondence to the level of transmittance, reflectance, or gray level required for an image. For field sequential displays that incorporate an analog gray scale, the feedback circuitry described above can still apply in a useful manner. Field sequential displays alternate or switch the illumination between a series of colored lamps. It is not necessary, however, that the switching frequency or the duty cycle of the illumination be kept constant through all operational modes of the display. For many applications it would be advantageous for an analog field sequential display to incorporate the ability to adjust lamp illumination times in response to the signals gathered from one or more of the sensors, such as sensors 802 or 902. Especially when the illumination times for the different colors are adjustable independently, it is possible to adjust the color balance between lamps by means of the timing control functions within circuits 800 and 900.

The invention may be embodied in other specific forms without departing from the spirit or essential characteristics thereof. The forgoing embodiments are therefore to be considered in all respects illustrative, rather than limiting of the invention.

1. A field sequential color display apparatus comprising:
a plurality of lamps, each capable of providing light of a different color,
a sensor capable of detecting information indicative of characteristics of light provided by each of the lamps and outputting a sensor signal based on the information, and
control circuitry for controlling illumination of each of the lamps, comprising
timing circuitry for controlling a length of time to illuminate each of the plurality of lamps and for outputting timing signals indicative thereof, and
lamp driver circuitry capable of outputting power to illuminate the plurality lamps based on the sensor signal and the timing signals.

2. The field sequential color display apparatus of claim 1, wherein the sensor includes a photosensor capable of measuring light intensity.

3. The field sequential color display apparatus of claim 2, wherein the photosensor is capable of measuring light intensity of ambient light and the sensor signal is based at least partially on the light intensity of the ambient light.

4. The field sequential color display apparatus of claim 1, comprising a second sensor capable of detecting second information indicative of characteristics of ambient light.

5. The field sequential color display apparatus of claim 1, wherein the sensor includes a thermal sensor capable of measuring temperature and the control circuitry includes a memory storing data that corresponds to a plurality of temperatures.

6. The field sequential color display apparatus of claim 1, wherein the timing circuitry determines the lengths of time to illuminate each of the plurality of lamps according to a time-division gray scale process.

7. The field sequential color display apparatus of claim 6, wherein the lamp driver circuitry adjusts the amplitude of the power output to illuminate at least one of the lamps based on the sensor signal.

8. The field sequential color display apparatus of claim 7, wherein the lamp driver adjusts the amplitude of the power output to illuminate the at least one lamp by adjusting a current level supplied to the at least one lamp.

9. The field sequential color display apparatus of claim 7, wherein the lamp driver adjusts the amplitude of the power output to illuminate the at least one lamp by adjusting a voltage level supplied to the at least one lamp.

10. The field sequential color display apparatus of claim 1, wherein the timing circuitry determines the lengths of time to illuminate each of the plurality of lamps according to a time-division gray scale process and the sensor signal.

11. The field sequential color display apparatus of claim 1, wherein the timing circuitry determines the lengths of time to illuminate each of the plurality of lamps according to an analog gray scale process and the sensor signal.

12. The field sequential color display apparatus of claim 1, wherein the sensor includes exactly one photosensor for measuring light intensity levels from each of the plurality of lamps.

13. The field sequential color display apparatus of claim 1, wherein in response to the sensor signal, the control circuitry adjusts a number of digital bit levels used to display an image.

14. The field sequential color display apparatus of claim 1, comprising a plurality of MEMS light modulators for modulating the light provided by the plurality of lamps.

15. The field sequential color display apparatus of claim 14, wherein the plurality of MEMS light modulators comprise shutter-based light modulators.

16. The field sequential color display apparatus of claim 14, wherein the timing circuitry is configured to control actuation of the plurality of MEMS light modulators.

17. The field sequential color display apparatus of claim 14, wherein the plurality of the MEMS light modulators and the sensor are formed on a common substrate.

18. A direct-view MEMS display apparatus comprising
a lamp capable of providing light,
a sensor capable of detecting information indicative of characteristics of light provided by the lamp and outputting a sensor signal based at least partially on the information, and
control circuitry for controlling illumination of the lamp based at least partially on the sensor signal.

19. The direct-view MEMS display apparatus of claim 18, comprising a plurality of MEMS light modulators for modulating the light provided by the lamp.

20. The field sequential color display apparatus of claim 19, wherein the plurality of MEMS light modulators comprise shutter-based light modulators.

21. The field sequential color display apparatus of claim 19, comprising timing circuitry configured for controlling actuation of the plurality of MEMS light modulators.

22. The field sequential color display apparatus of claim 19, comprising timing circuitry configured for controlling lengths of time the lamp is illuminated.

23. The field sequential color display apparatus of claim 19, comprising timing circuitry configured for controlling actuation of the plurality of MEMS light modulators and the lengths of time the lamp is illuminated.

24. The field sequential color display apparatus of claim 19, wherein the plurality of the MEMS light modulators and the sensor are formed on a common substrate.
